(19) United States
(12) Patent Application Publication
(10) Pub. No.: US 2014/0144151 A1
(43) Pub. Date: May 29, 2014

(54) Engine Compressor Wash System

(71) Applicant: UNITED TECHNOLOGIES CORPORATION, Hartford, CT (US)

(72) Inventor: Anthony R. Bifulco, Ellington, CT (US)

(73) Assignee: UNITED TECHNOLOGIES CORPORATION, Hartford, CT (US)

(21) Appl. No.: 13/689,305

(22) Filed: Nov. 29, 2012

(51) Int. Cl. F02C 3/04; B23P 6/00; F02C 9/00

(52) U.S. Cl. CPC F02C 3/04; F02C 9/00; B23P 6/00
USPC 60/772; 60/726; 29/888.011

(57) ABSTRACT

A gas turbine engine includes: a compressor; a combustor downstream of the compressor along a gaspath; a turbine downstream of the combustor along the gaspath; a plurality of wash nozzles having outlets along the gaspath; and at least one inlet fitting coupled to the wash nozzles to bound a wash flowpath from an inlet port of the at least one inlet fitting to said outlets of said nozzles. The plurality of stages include: a stage upstream of blades of one compressor section; and another stage between said blades of one compressor section and blades of another compressor section.

### BACKGROUND

The disclosure relates to gas turbine engines. More particularly, the disclosure relates to washing of gas turbine engines.

In an exemplary method of washing a gas turbine engine, a nozzle wand is inserted into the engine inlet. A wash fluid (e.g., water) is sprayed through the wand. In a baseline washing process using a wand to wash a turbofan engine, much of the wash fluid will not even enter the core flowpath. Much will be slung centrifugally from the fan and pass along the bypass flowpath or drip off. Of the fluid entering the core flowpath, its distribution may become uneven both radially and circumferentially. For example, centrifugal action may generally bias the fluid outboard while gravity may bias the fluid downward.

Accordingly, integrated wash systems have been proposed. US20120134777, US8245952, and US20110197923 all disclose integrated wash systems.

### SUMMARY

One aspect of the disclosure involves a gas turbine engine comprising: a compressor; a combustor downstream of the compressor along a gaspath; a turbine downstream of the combustor along the gaspath; a plurality of wash nozzles having outlets along the gaspath; and at least one inlet fitting coupled to the wash nozzles to bound a wash flowpath from an inlet port of the at least one inlet fitting to said outlets of said nozzles. The plurality of stages include: a stage upstream of blades of one compressor section; and another stage between said blades of one compressor section and blades of another compressor section.

In one or more embodiments of any of the foregoing embodiments, the nozzles extend within associated vanes, the vanes radially extending between inboard and outboard boundaries of the gaspath.

In one or more embodiments of any of the foregoing embodiments, there are no further stages of said nozzles.

In one or more embodiments of any of the foregoing embodiments, said another stage is formed along an intermediate case.

In one or more embodiments of any of the foregoing embodiments, the nozzles comprise a cast-in leg of a strut.

In one or more embodiments of any of the foregoing embodiments, the cast-in leg is along a trailing edge wall of the strut aft of a cavity.

In one or more embodiments of any of the foregoing embodiments, the fitting is located between an outboard wall of the gaspath and an access panel.

In one or more embodiments of any of the foregoing embodiments, the engine is a turbofan engine and the access panel is along an inboard boundary of a bypass flowpath.

In one or more embodiments of any of the foregoing embodiments, the nozzle outlets are positioned to discharge wash streams to directly impact one or more compressor blades.

In one or more embodiments of any of the foregoing embodiments, a comprises: coupling a wash fluid source to said at least one fitting; and delivering pressurized wash fluid from the wash fluid source to discharge from said nozzle outlets.

In one or more embodiments of any of the foregoing embodiments, the coupling of the wash fluid source comprises coupling the wash fluid source to respective said fittings associated with respective said nozzles.

In one or more embodiments of any of the foregoing embodiments, the wash fluid is introduced while the engine is running.

In one or more embodiments of any of the foregoing embodiments, the wash fluid is by weight majority water.

In one or more embodiments of any of the foregoing embodiments, the method further comprises removing at least one access panel to provide access to the fitting.

In one or more embodiments of any of the foregoing embodiments, a gas turbine engine compressor inlet strut comprises: an inner platform for bounding an inner periphery of a gaspath; an outer shroud for bounding an outer perimeter of the flowpath; and a nozzle having an outlet along the strut and a passageway defined by a casting and extending outboard to an inlet fitting.

In one or more embodiments of any of the foregoing embodiments, a method for remanufacturing a gas turbine engine, the method comprises: removing a compressor inlet strut lacking a wash nozzle; and replacing the removed compressor inlet strut with the aforementioned strut.

The details of one or more embodiments are set forth in the accompanying drawings and the description below. Other features, objects, and advantages will be apparent from the description and drawings, and from the claims.

### BRIEF DESCRIPTION OF THE DRAWINGS

FIG. 1 is a partially schematic half-sectional view of a turbofan engine.

FIG. 1A is an enlarged view of compressor sections of the engine of FIG. 1.

FIG. 2 is an isolated cutaway view of a front centerbody (aka, inlet or fan intermediate case) of the engine of FIG. 1.

FIG. 3 is an isolated cutaway view of an intermediate case of the engine of FIG. 1.

Like reference numbers and designations in the various drawings indicate like elements.

### DETAILED DESCRIPTION

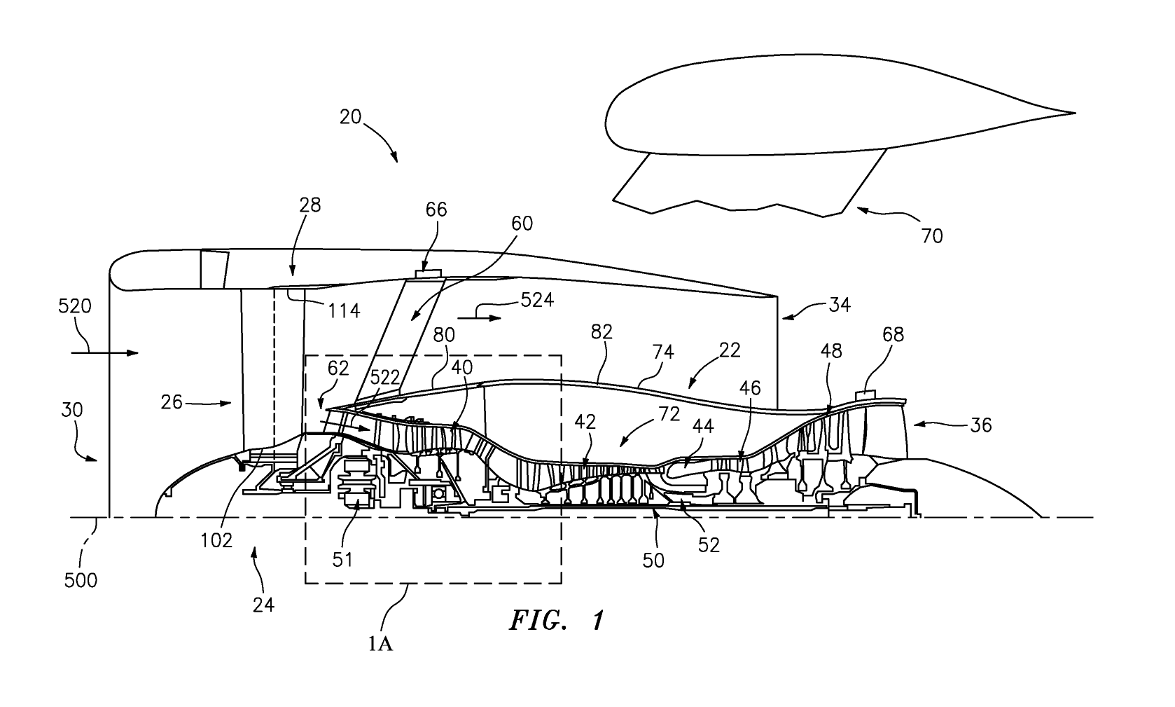

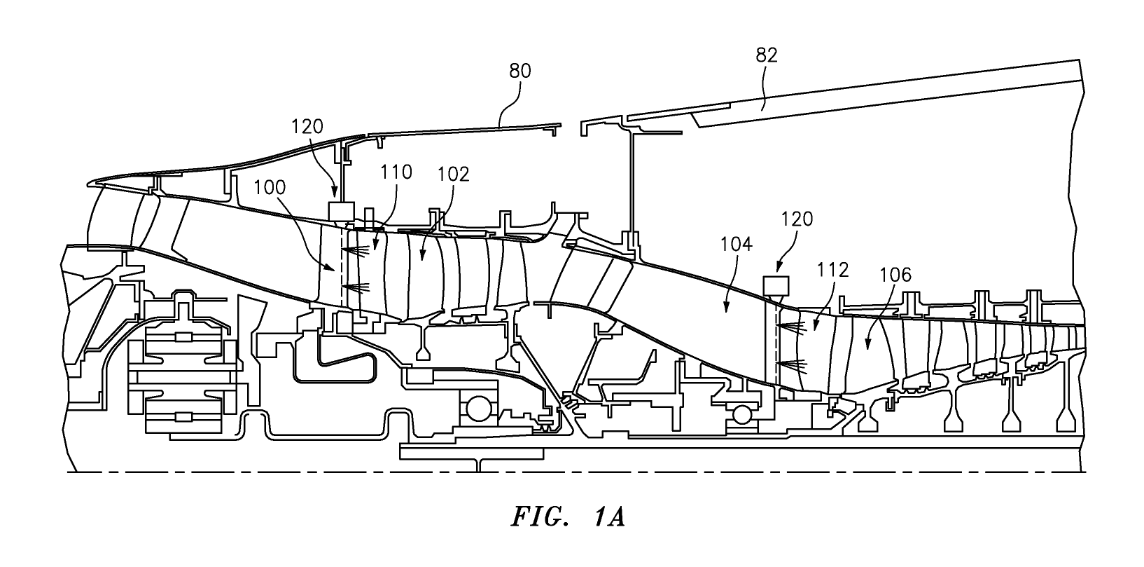

FIG. 1 shows a gas turbine engine 20 having an engine case 22 surrounding a centerline or central longitudinal axis 500. An exemplary gas turbine engine is a turbofan engine having a fan section 24 including a fan 26 within a fan case 28. The exemplary engine includes an inlet 30 at an upstream end of the fan case receiving an inlet flow along an inlet flowpath 520. The fan 26 has one or more stages of fan blades 32. Downstream of the fan blades, the flowpath 520 splits into an inboard portion 522 being a core flowpath and passing through a core of the engine and an outboard portion 524 being a bypass flowpath exiting an outlet 34 of the fan case.

The core flowpath 522 proceeds downstream to an engine outlet 36 through one or more compressor sections, a combustor, and one or more turbine sections. The exemplary engine has two axial compressor sections and two axial turbine sections, although other configurations are equally applicable. From upstream to downstream there is a low pressure compressor section (LPC) 40, a high pressure compressor section (HPC) 42, a combustor section 44, a high pressure turbine section (HPT) 46, and a low pressure turbine section (LPT) 48. Each of the LPC, HPC, HPT, and LPT comprises one or more stages of blades which may be interspersed with one or more stages of stator vanes.

In the exemplary engine, the blade stages of the LPC and LPT are part of a low pressure spool mounted for rotation about the axis 500. The exemplary low pressure spool includes a shaft (low pressure shaft) 50 which couples the blade stages of the LPT to those of the LPC and allows the LPT to drive rotation of the LPC. In the exemplary engine, the shaft 50 also drives the fan. In the exemplary implementation, the fan is driven via a transmission 51 (e.g., a fan gear drive system such as an epicyclic transmission) to allow the fan to rotate at a lower speed than the low pressure shaft.

The exemplary engine further includes a high pressure shaft 52 mounted for rotation about the axis 500 and coupling the blade stages of the HPT to those of the HPC to allow the HPT to drive rotation of the HPC. In the combustor 44, fuel is introduced to compressed air from the HPC and combusted to produce a high pressure gas which, in turn, is expanded in the turbine sections to extract energy and drive rotation of the respective turbine sections and their associated compressor sections (to provide the compressed air to the combustor) and fan.

FIG. 1 further shows the fan case 28 supported relative to the engine core via a circumferential array of struts 60. Inboard ends of the struts may be integral with a splitter 62. Outboard ends of the struts may be integral with a mounting ring having a yoke or other mounting feature 66. The mounting feature 66 and a mounting feature 68 to the rear of the case may mount the engine to a mounting pylon 70 (e.g., from a wing of an aircraft).

FIG. 1 further shows the engine case structure 44 as comprising a main or inner or core case 72 and an outer case or aerodynamic nacelle 74. As is discussed further below, the nacelle 74 may include access panels 80 and 82 (e.g., a circumferential array of such panels).

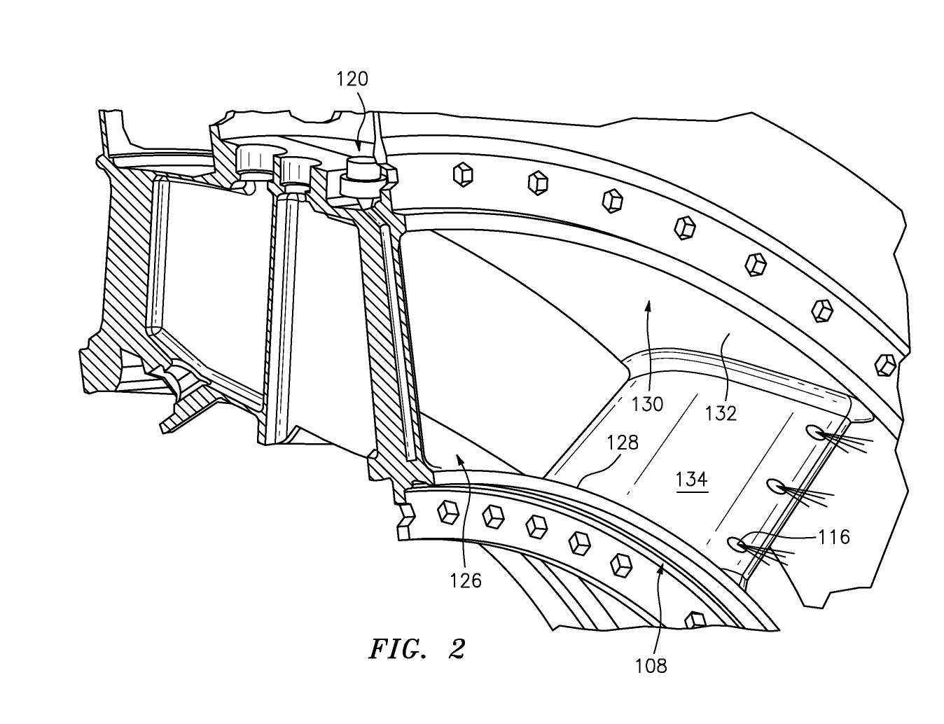

FIG. 1A shows an integral wash system which may introduce wash fluid close to the compressor blade stages. The exemplary wash system comprises fixed nozzles mounted within the engine. The exemplary nozzles are mounted within vane or strut structures. FIG. 2 shows a stage of LPC inlet struts 100 ahead of the first blade stage 102 of the LPC. Similarly, an HPC inlet stage of struts 104 is ahead of the first blade stage 106 of the HPC. The struts may be manufactured via generally conventional processes and materials and may be singlets, doublets, full annuli, or other groupings. The exemplary struts 100 are formed as part of a front center body 108 (FIG. 2).

In the exemplary implementation, the nozzles are spaced apart from the adjacent blade stage 102, 106 by a respective variable vane stage 110, 112. Alternative implementations may place the nozzles immediately ahead of the blade stages without intervening variable vanes. In a given stage of the struts 100, 104, every strut may contain a nozzle 114 or only some of the struts might contain nozzles (e.g., an alternating pattern of nozzled struts versus nozzle-free struts).

Each exemplary nozzle 114 (FIG. 2) comprises one or more outlets 116 and a passageway to such outlets along a wash fluid flowpath from an inlet fitting 120. The exemplary inlet fitting 120 is positioned outboard. In this example, the strut comprises a platform 126 having an outboard surface 128 defining an inboard perimeter of the core flowpath. The strut comprises an outer shroud 130 having an inboard surface 132 locally defining an outboard boundary of the core flowpath. An airfoil structure 134 extends between the platform and shroud. The exemplary nozzle outlets are along the airfoil structure.

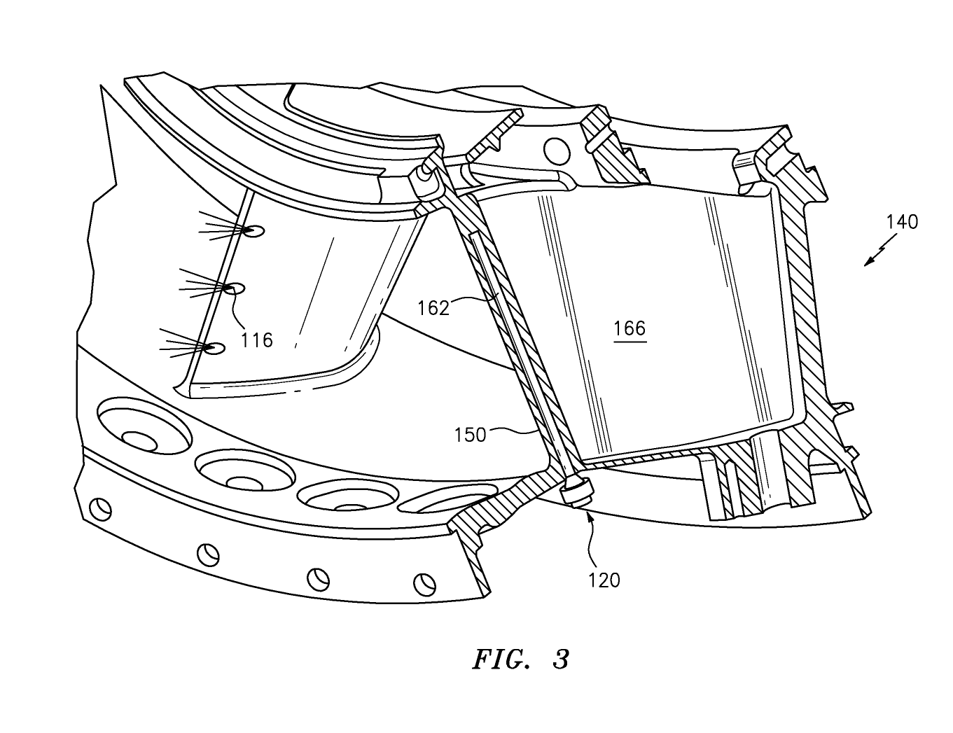

FIG. 3 shows the exemplary HPC washing stage as formed along the struts of an intermediate case 140. In the exemplary embodiment, in both the LPC washing stage and HPC washing stage, the outlets are on both circumferential faces of the associated struts (e.g., a pressure side and a suction side if airfoil-shaped) closely ahead of the strut trailing edge 150.

In the exemplary implementation, the struts are cast (e.g., of an alloy such as a titanium alloy or steel) and at least main passageway legs 162 are cast in place in a trailing edge portion 164 of the casting. The exemplary trailing edge portion 164 is to the rear of a hollow interior 166. The exemplary outlets 116 may be cast in place along with the main passageway leg 162 or machined after casting (e.g., drilled into the passageway leg 162). At the outboard end of the strut, a fitting interface may be machined (e.g., a threaded bore) to which a machined fitting 120 is mated (e.g., threaded in place). Alternative nozzles might be separately formed and then joined/attached to the struts.

In the exemplary embodiment, each individual nozzle 114 has its own associated fitting 120. The fittings may be located between the outboard perimeter of the core flowpath and the inboard perimeter of the bypass flowpath. Along such inboard perimeter of the bypass flowpath, the engine nacelle may include one or more circumferential arrays of removable access panels 80 and 82 (e.g., secured via threaded fasteners). The access panels may provide access to the fittings 120.

In normal operation, the fittings may be closed and sealed (e.g., capped via threaded-on caps). This may prevent undesirable reverse airflows through the nozzle. For engine washing, the access panels 80, 82 may be removed and caps (if any) removed from the fittings 120. Wash hoses (not shown) may be connected to the fittings (e.g., wash hose fittings screwed onto the fittings 120) to deliver wash fluid from a remote source (e.g., a pump cart or truck (not shown)). With the source coupled to the nozzles, the engine may be run (e.g., at low power such as ground idle to limit pump pressure to overcome gas pressure at the HPC inlet) while wash fluid is delivered through the nozzles. Fluid exiting the nozzles may directly impact the passing blades of the adjacent blade stage. The wash fluid will pass downstream along the core flowpath.

In another variation, all the nozzles of one or both stages or groups within a stage may be connected to one or more manifolds (not shown) so that a single fitting may feed multiple nozzles (some-to-all nozzles of one stage or both stages).

Cleaning of the HPC may be particularly useful for one or more of several reasons. First, the HPC may account for a greater portion of the engine's fuel burn than does the LPC (thereby potentially offering greater impact on efficiency when the HPC is dirty relative to when the LPC is dirty). Cleaning via a locally-introduced flow may be more effective than cleaning with a remotely-introduced flow (e.g. the flow introduced at the LPC inlet). For example, if there only was wash introduction at the LPC, there might be a tendency to drive dirt/debris from the LPC into the HPC but without fully evacuating such dirt/debris. Full evacuation of such dirt might require an extremely long duration of wash. Alternatively, it might require a two-step wash in which a first step involves opening a low compressor bleed (e.g., the 2.5 bleed) so dirt/debris from upstream thereof is expelled from the engine without passing through downstream portions of the core including the HPC. In the second step, the bleed is closed and the wash fluid first passes through the already-cleaned portions of the LPC before passing through the uncleaned portions of the LPC and the HPC. By having multiple locations of fluid introduction, a more effective and potentially more efficient cleaning may be achieved.

One or more embodiments have been described. Nevertheless, it will be understood that various modifications may be made. For example, when applied in the redesign of a baseline engine configuration or for the remanufacturing of a baseline engine, details of the baseline will influence details of any particular implementation. Accordingly, other embodiments are within the scope of the following claims.

1. A gas turbine engine comprising:
a compressor;
a combustor downstream of the compressor along a gaspath; and
a turbine downstream of the combustor along the gaspath, the engine further comprising:
a plurality of wash nozzles having outlets along the gaspath; and
at least one inlet fitting coupled to the wash nozzles to bound a wash flowpath from an inlet port of the at least one inlet fitting to said outlets of said nozzles, wherein:
said plurality of stages include:
a stage upstream of blades of one compressor section; and
another stage between said blades of one compressor section and blades of another compressor section.

2. The engine of claim 1 wherein:
the nozzles extend within associated airfoils, the airfoils radially extending between inboard and outboard boundaries of the gaspath.

3. The engine of claim 1 wherein:
there are no further stages of said nozzles.

4. The engine of claim 1 wherein:
said another stage is formed along an intermediate case.

5. The engine of claim 1 wherein:
the nozzles comprise a cast-in leg of a strut.

6. The engine of claim 5 wherein:
the cast-in leg is along a trailing edge wall of the strut aft of a central cavity.

7. The engine of claim 1 wherein:
the fitting is located between an outboard wall of the gaspath and an access panel.

8. The engine of claim 7 wherein:
the engine is a turbofan engine; and
the access panel is along an inboard boundary of a bypass flowpath.

9. The engine of claim 1 wherein:
the nozzle outlets are positioned to discharge wash streams to directly impact one or more compressor blades.

10. A method for using the engine of claim 1, the method comprising:
coupling a wash fluid source to said at least one fitting; and
delivering pressurized wash fluid from the wash fluid source to discharge from said nozzle outlets.

11. The method of claim 10 wherein:
the coupling of the wash fluid source comprises coupling the wash fluid source to respective said fittings associated with respective said nozzles.

12. The method of claim 10 wherein:
the wash fluid is introduced while the engine is running.

13. The method of claim 10 wherein:
the wash fluid is by weight majority water.

14. The method of claim 10 further comprising:
removing at least one access panel to provide access to the fitting.

15. A gas turbine engine compressor inlet strut comprising:
an inner platform for bounding an inner periphery of a gaspath;
an outer shroud for bounding an outer perimeter of the flowpath; and
a nozzle having an outlet along the strut and a passageway defined by a casting and extending outboard to an inlet fitting.

16. A method for remanufacturing a gas turbine engine, the method comprising:
removing a compressor inlet strut lacking a wash nozzle; and
replacing the removed compressor inlet strut with the strut of claim 15.
